(19) United States
(12) Patent Application Publication
(10) Pub. No.: US 2004/0220851 A1
(43) Pub. Date: Nov. 4, 2004

(54) System and method for advertiser-sponsored phone service

(76) Inventors: Edward Michael Silver, Atlanta, GA (US); Hong Thi Nguyen, Atlanta, GA (US); Vernon Meadows, Lilburn, GA (US)

Correspondence Address: BELLSOUTH CORPORATION, P.O. BOX 2903, MINNEAPOLIS, MN, 55402-0903, US

(21) Appl. No.: 10/368,903

(22) Filed: Feb. 18, 2003

(51) Int. Cl. G06F 17/60

(52) U.S. Cl. 705/14

(57) ABSTRACT

Systems and methods for presenting an advertisement to a telecommunications service subscriber are described. In an embodiment of the present invention, an advertisement player receives a signal indicating the termination of a telephone call. In response, the advertisement player plays an advertisement in lieu of a conventional ring tone. The advertisement player is in communication with a telecommunications network and may periodically download advertisements. In one embodiment, an advertiser associates demographics with an advertisement. In such an embodiment, the service provider matches the advertisements to be downloaded to subscriber profiles based on the demographics.

### NOTICE OF COPYRIGHT PROTECTION

A portion of the disclosure of this patent document and its figures contain material subject to copyright protection. The copyright owner has no objection to the facsimile reproduction by anyone of the patent document, but otherwise reserves all copyrights whatsoever.

### FIELD OF THE INVENTION

The present invention generally relates to the provision of telecommunications service. The present invention more particularly relates to presenting advertising to a user of telecommunications services.

### BACKGROUND

Reaching consumers through conventional advertising channels, including television, print media, and, more recently, the Internet, has become increasingly more difficult. And reaching a targeted subset of consumers who, based on demographics, are most likely to purchase the advertiser's products or services has become even more difficult.

For example, television viewers have access to potentially hundreds of television channels. Determining on which channels to present an advertisement requires a great deal of information regarding the programming appearing on the channel and regarding the demographics of viewers tuning to the channel at various times of the day. Also, viewers have historically surfed television channels during commercial breaks, making the task of targeting consumers using this conventional advertising channel all the more difficult. In addition, newer technologies, such as personal digital video recorders, allow a television viewer to explicitly avoid an advertiser's commercials.

Telemarketers have also sent their attempts to reach consumers thwarted. However, with the advent of technology such as caller identification (caller-ID), TeleZapper™ and the like, advertisers have found it increasingly more difficult to reach these individuals effectively. Internet advertisers face similar challenges. For example, advertisement-blocking software that allows a computer user to stop the proliferation of pop-up and other advertisements has become widespread.

In addition to the problems of reaching potential consumers in generally and in reaching targeted consumers specifically, using conventional channels for advertising can be cost prohibitive. Television commercials may require millions of dollars to produce and air, and even simple Internet pop-up ads may cost thousands of dollars to create and distribute.

A system and method for inexpensively and efficiently reaching targeted customers is needed.

### SUMMARY

Embodiments of the present invention provide systems and methods for substituting an advertisement for a conventional ring tone. One embodiment of the present invention comprises a telecommunications network and an advertisement player in communication with the telecommunications network. The advertisement player is configured to present an advertisement in response to receiving a signal indicating reception of a telephone call.

An embodiment may also comprise a data store in communication with the telecommunications network for storing the advertisements. In one embodiment, the advertisement player may be integrated into a network end point, such as an Internet protocol (IP) telephone. In one embodiment, the advertisement player comprises an MP3 player.

When the advertisement player receives a signal that indicates reception of a telephone call, the advertisement player present an advertisement in lieu of providing a conventional ring tone. For example, the advertisement player may present the jingle of an advertiser when a call is received. The advertisement player may be preconfigured with an advertisement to play or may periodically receive and store advertisements across the telecommunications network. In an embodiment in which the advertisement player receives the advertisement from the network, the service provider transmits the advertisement in response to the advertisement player's request. The service provider may receive the advertisement as well as associated demographics from the advertiser.

The advertisement player may present different advertisements based on the directory number called. For example, a network end point may serve as the termination point for multiple directory numbers. If so, the advertisement player determines the directory number dialed and plays the appropriate advertisement.

An embodiment of the present invention provides numerous advantages over advertising through conventional advertising channels. An embodiment of the present invention is simple to deploy and is compatible with both packet and circuit-switched networks, requiring no changes to the call-handling procedures in the telecommunications network. Also, by presenting the advertisement in lieu of a conventional ring tone, the advertiser is more likely to ensure that the subscriber is presented with the advertisement. Further, since the advertiser is able to utilize demographics to identify the subscriber to which the advertisement is targeted, the advertisement is more likely to be successful than an advertisement directed at a random population of potential customers.

Further details and advantages of the present invention are set forth below.

### BRIEF DESCRIPTION OF THE FIGURES

These and other features, aspects, and advantages of the present invention are better understood when the following Detailed Description is read with reference to the accompanying drawings, wherein:

FIG. 1 illustrates an exemplary environment for implementation of one embodiment of the present invention;

FIG. 2 is a flow chart, illustrating a process for periodically downloading an advertisement file in an embodiment of the present invention;

FIG. 3 is a flow chart, illustrating a process for providing an advertisement file in response to a call in an embodiment of the present invention;

FIG. 4 is a flow chart, illustrating a process for creating an advertisement file in an embodiment of the present invention; and

FIG. 5 is a flow chart, illustrating a process for associating an advertisement file with a directory number in an embodiment of the present invention.

### DETAILED DESCRIPTION

Embodiments of the present invention provide systems and methods for providing an advertisement to a telecommunications service subscriber. An embodiment of the present invention includes an advertisement player in communication with a telecommunications network. The advertisement player is communication with an end point of the network, such as a telephone. When the advertisement player receives a signal indicating that a telephone call has been directed a directory number terminated at the end point, the advertisement player plays an advertisement in place of a conventional ring tone.

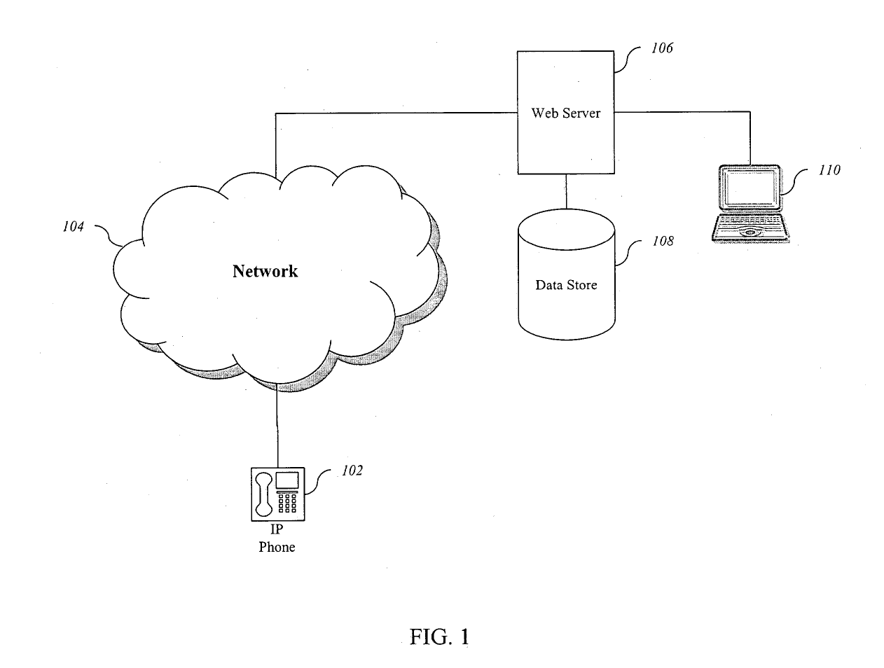

Referring now to the drawings in which like numerals indicate like elements throughout the several Figures, FIG. 1 is a block diagram illustrating an exemplary environment for one embodiment of the present invention. In the embodiment shown, an Internet protocol (IP) phone 102 is in communication with a telecommunications network 104. The IP phone 102 includes an advertisement player. In other embodiments, the advertisement player is separate from the phone and in communication with either the phone or with the network at the termination point.

The advertisement player is capable of reading, interpreting, and presenting the file in which the advertisement is stored. The advertisement player comprises hardware and software and may comprise a stand-alone component or may be integrated into another component, such as the IP phone (102). To implement the various methods according to the present invention, the advertisement player comprises program code stored on a computer-readable medium.

An embodiment of a suitable computer-readable medium includes an electronic, optical, magnetic, or other storage or transmission device capable of providing a processor, such as the processor in the web server 106, with computer-readable instructions. Other examples of suitable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. Also, various other forms of computer-readable media may transmit or carry instructions to a computer, including a router, private or public network, or other transmission device or channel.

In one embodiment, the advertisement comprises a Moving Picture Experts Group Layer-3 Audio (MP3) file, and the advertisement player is an MP3 player with an integrated speaker. In another embodiment, the advertisement player is a multimedia player capable of presenting MP3, MPEG, and other multimedia files and includes an integrated display and an integrated speaker. The network end point may comprise a phone connected to a circuit-switched network, a personal computer, or any other device capable of receiving a call and of communicating with an advertisement player.

Various combinations of network end point and advertisement player may be utlized. For example, in one embodiment, the advertisement player is in communication with a packet-switched network, and the phone is in communication with a circuit-switched network. The advertisement player receives advertisement files via the packet-switched network, and the phone receives calls via the circuit-switched network. The phone is in further communication with the advertisement player, providing the signal to trigger presentation of the advertisement when a call is received.

The network 104 may comprise a public, private, or governmental circuit or packet-switched network. For example, in one embodiment, the network 104 is the Internet. The IP telephone 102 communicates over the network 104 using standard networking protocols, such as TCP/IP.

A web server 106 is also in communication with the network 106. The web server comprises a processor, memory, and programming code stored on computer-readable media to implement the methods of the present invention. The web server 106 receives requests, such as HTTP requests, and responds by providing both static and dynamic content.

The web server is also in communication with a data store 108. In one embodiment, the data store 108 comprises a relational database, such as an ORACLE® relational database. In the embodiment shown, the data store 108 comprises a separate component. In other embodiments, the data store 108 is integrated with the web server 106.

In the embodiment shown in FIG. 1, a personal computer 110 is in direct communication with the web server 106. The personal computer 110 includes hardware and software, including program code stored on a computer-readable medium, that allows an administrator to make additions or changes to programs executing on the web server 106 and/or to data residing in the data store 108. For example, an administrator may use personal computer 106 to load new subscriber profiles into data store 108.

In embodiments of the present invention, an advertiser provides a service provider with an advertisement file. The service provider makes the advertisement file available for download to the network end point. The network end point subsequently downloads the advertisement and in response to an incoming call, presents the advertisement.

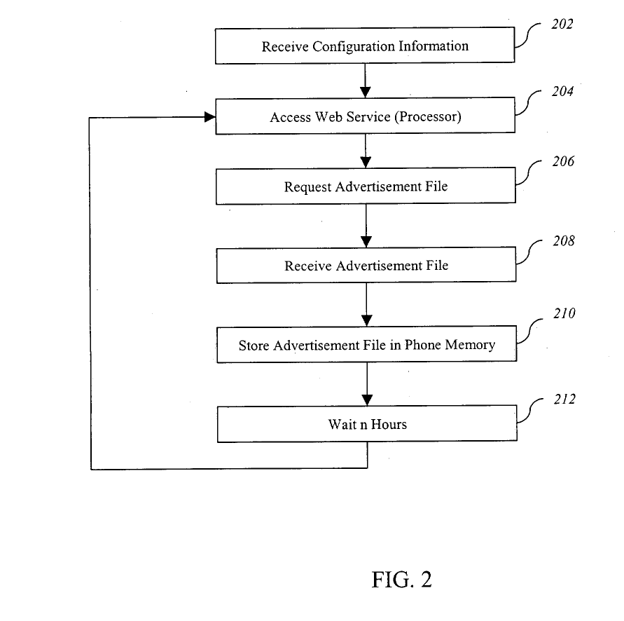

FIG. 2 is a flow chart, illustrating the process of periodically retrieving the advertisement file in an embodiment of the present invention. To receive the advertisement file, the advertisement player, such as the IP phone (102) shown in FIG. 1, requires configuration information. The configuration information may include the network address of the web server (106), the types of files that the IP phone (102) is capable of presenting to a user, an identifier of the user, and other user, player, or directory number specific information.

Once the IP phone (102) has received configuration information, the IP phone (102) submits a request to the web server (106) 202. In the embodiment shown, the request comprises a hypertext transfer protocol (HTTP) request directed to program code executing on the web server (106) to provide an advertisement file 206. The request comprises an identifier of the requesting IP phone (102), such as the directory number, and may include other relevant information.

In response to receiving the request, the web server 106 transmits an advertisement file to the IP phone (102). The IP phone (102) receives the advertisement file 208 and stores it in memory 210. Depending on the size of the advertisement file and of the memory available for storage, the IP phone (102) may store multiple advertisements and may implement a method for removing from memory previously downloaded files. The IP phone (102) then waits a specified number (n) of hours 212 and then repeats the process of retrieving and storing the file 204-210. In other embodiments, the IP phone (102) plays an advertisement a specified number (×) times and then downloads a replacement or additional file.

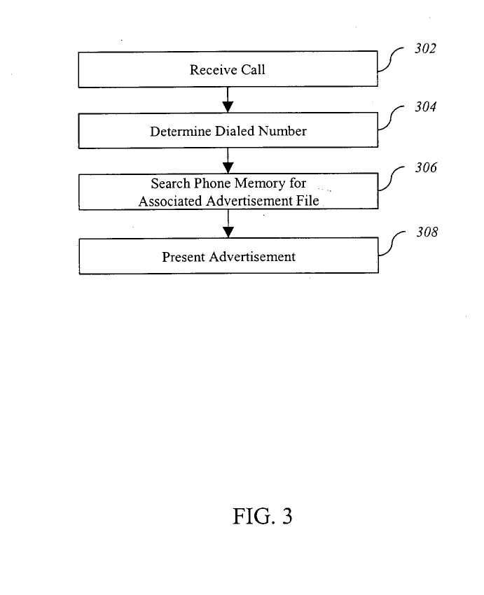

Once the IP phone (102) has received and stored the file, the IP phone (102) can present the content of the file to a subscriber. FIG. 3 is a flow chart, illustrating a process of presenting an advertisement to a subscriber of the IP phone (102). The IP phone (102) receives a call 302. The call is placed and received in a conventional manner; no call-processing changes are necessary. In the embodiment shown, the advertisement player is integrated into the IP phone (102); in other embodiments, the advertisement player comprises a separate device. The IP phone (102) determines the dialed number 304. For example, in one embodiment of the present invention, the IP phone (102) comprises a two-line phone. Therefore, either of two directory numbers is terminated at the IP phone (102). Also, in one embodiment, each of the lines is associated with a different set of demographics. For example, the first line may be for a home phone and the second line for a business phone. The advertisements targeted to each of these directory numbers may be different.

The IP phone (102) searches its memory for the advertisement file associated with the dialing number called 306. Once the IP phone (102) finds the advertisement file, it presents the advertisement to the user.

For example, in one embodiment, the advertisement file comprises a jingle created and saved in an MP3 format. When a telephone call is received, the IP phone (102) plays the MP3 file comprising the jingle instead of a conventional ring tone. In another embodiment, the advertisement comprises a multimedia file that includes both audio and video. When a telephone call is received, the advertisement is displayed on the display integrated into the IP phone (102).

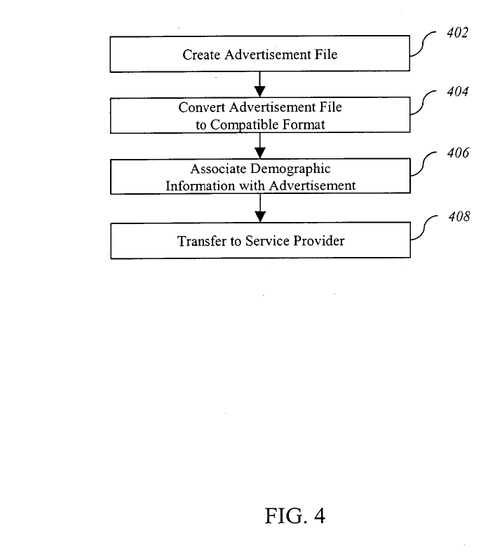

FIG. 4 is a flow chart, which illustrates the process of creating, converting, and transferring a multimedia file in one embodiment of the present invention. In the embodiment shown, an advertiser creates a multimedia file 402. For example, the advertiser may create a file in a musical instrument digital interface (MIDI) format. The advertiser next converts the multimedia file into a format that is compatible with the advertisement players in communication with the network (104) 404. For example, an advertiser may convert the MIDI file to an MP3 file. The advertiser associates demographic information with the file to enable the targeting of advertisements to desirable customers 406. The advertiser transfers the converted file and associated graphics to the service provider 408. The service provider stores the file on a server, such as web server (106), from which the advertisement players can access the file.

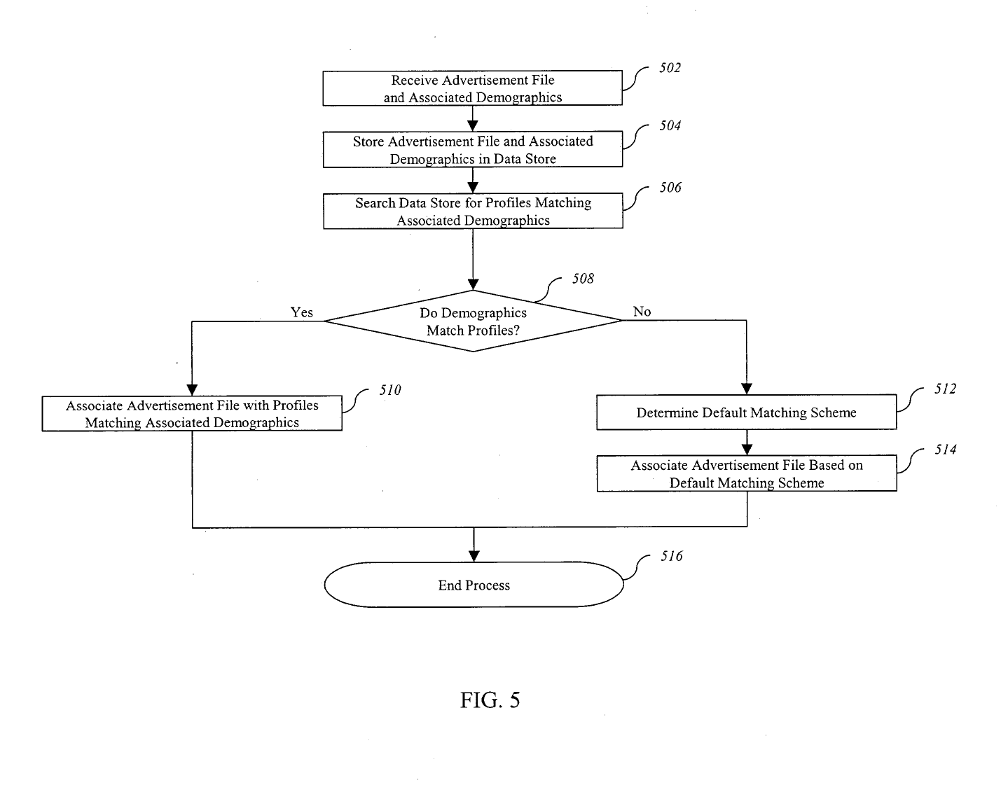

FIG. 5 is a flow chart, illustrating the process of receiving and storing the advertisement file in one embodiment of the present invention. In the embodiment shown, the service provider receives a multimedia file and associated demographics from an advertiser on the web server (106) via the network (104) 502. The advertiser stores the advertisement file and associated demographics in the data store (108) 504. The service provider then searches for subscriber profiles matching the demographics supplied by the advertiser 506. For example, the subscriber profile may include the ages of occupants of the subscriber's residence. This information may be valuable to an advertiser. The service provider determines whether the demographics associated with the advertisement file match any of the subscriber profiles 508. If so, the service provider associates the advertisement file with the profiles matching the associated demographics 510. Subsequently, when the IP phone (102) accesses the web server (106), the advertisement file will be provided to the IP phone (102) based on this association.

In the embodiment shown, if the demographics do not match any profiles, the service provider determines which default matching scheme should be utilized 512. For example, the service provider may determine that an advertisement be directed to one-fourth of all subscribers in a certain community. The default matching routine specifies that every fourth subscriber in an alphabetical list of subscribers within the community is to be associated with the advertisement file. The service provider then utilizes the default matching scheme to associate the advertisement file with profiles 514. The process then ends 516.

A subscriber profile may be associated with zero, one, or many advertisement files. In one embodiment, each time the IP phone (102) accesses the web server (106) to retrieve an advertisement file, the web server (106) provides a file that is different from the one sent during the previous transaction. In this manner, a service provider ensures that all advertisements are presented.

The service provider may bill the subscriber using a number of different methods. For example, in one embodiment, the service provider bills the subscriber for each download of an advertisement file to a subscriber. In another embodiment, the service provider bills the subscriber for each presentation of an advertisement. The service provider ascertains which advertisement is presented by determining when a telephone call was terminated at a directory number for which an advertisement had been downloaded. In yet another embodiment, the service provider charges the advertiser based on the demographics the advertiser uses to target potential consumers. For example, highly specific targeting results in a higher download or presentation charge.

Embodiments of the present invention may be implemented so as to provide incentives to the service provider's subscribers. In one embodiment of the present invention, the service provider provides a discount to the subscriber for allowing advertisements to be presented in lieu of a conventional ring tone. In other embodiments, the advertisements comprise discounts available only to subscribers who receive the advertisements.

The foregoing description of the preferred embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

That which is claimed:

1. A method for providing advertising to a subscriber, comprising:
receiving a signal indicating reception of a telephone call; and
presenting an advertisement in response to said signal.

2. The method of claim 1, wherein said advertisement comprises an MP3 file.

3. The method of claim 1, wherein said presenting comprises an IP telephone playing a musical composition in lieu of a conventional ring tone.

4. The method of claim 1, further comprising:
requesting an advertisement file through a telecommunications network;
receiving an advertisement from said telecommunications network; and
storing said advertisement.

5. The method of claim 2, further comprising transmitting said advertisement in said telecommunications network.

6. The method of claim 1, wherein said advertisement player comprises a telephone.

7. The method of claim 6, wherein said telephone comprises an Internet protocol (IP) telephone.

8. The method of claim 1, further comprising periodically downloading said advertisement from a telecommunications network.

9. The method of claim 1, further comprising before said presenting:
identifying the directory number to which said telephone call is directed; and
retrieving an advertisement associated with said directory number.

10. The method of claim 1, further comprising billing an advertiser for presenting said advertisement.

11. The method of claim 1, further comprising crediting a telecommunications service account for presenting said advertisement.

12. A method for providing advertising to a subscriber, comprising:
receiving a request for an advertisement file to be played in lieu of a conventional ring tone;
retrieving said advertisement file from a data store; and
providing said advertisement file in response to said request.

13. The method of claim 12, wherein said retrieving of said advertisement file comprises:
retrieving demographics information from a subscriber profile; and
retrieving said advertisement file corresponding to said demographics information.

14. A system for providing advertising to a consumer, comprising:
a telecommunications network;
a network end point in communications with said telecommunications network; and
an advertisement player in communications with at least one of said telecommunications network and said network end point for presenting an advertisement in response to receiving a signal indicating reception of a telephone call.

15. The system of claim 14, further comprising an advertisement data store in communication with said telecommunications network.

16. The system of claim 14, wherein said network end point comprises said advertisement player.

17. The system of claim 14, wherein said network end point comprises an Internet protocol (IP) telephone.

18. The system of claim 14, wherein said advertisement player comprises an MP3 player.

19. The system of claim 14, further comprising:
a web server in communication with said telecommunications network; and
a data store in communication with said web server.

20. A computer-readable medium on which is encoded computer program code for providing advertising to a subscriber, comprising:
program code for receiving a signal indicating reception of a telephone call; and
program code for presenting an advertisement in response to said signal.

21. The computer-readable medium of claim 20, further comprising:
program code for requesting an advertisement file through a telecommunications network;
program code for receiving an advertisement from said telecommunications network; and
program code for storing said advertisement.

22. The method of claim 2, further comprising program code for transmitting said advertisement in said telecommunications network.

23. The computer-readable medium of claim 20, further comprising program code for periodically downloading said advertisement from a telecommunications network.

24. The computer-readable medium of claim 20, further comprising: program code for identifying the directory number to which said telephone call is directed; and
program code for retrieving an advertisement associated with said directory number.

25. The computer-readable medium of claim 20, further comprising program code for billing an advertiser for presenting said advertisement.

26. The computer-readable medium of claim 20, further comprising program code for crediting a telecommunications service account for presenting said advertisement.

27. A computer-readable medium on which is encoded computer program code for providing advertising to a subscriber, comprising:
program code for receiving a request for an advertisement file to be played in lieu of a conventional ring tone;
program code for retrieving said advertisement file from a data store; and
program code for providing said advertisement file in response to said request.

28. The computer-readable medium of claim 27, wherein said program code for retrieving said advertisement file comprises:
program code for retrieving demographics information from a subscriber profile; and
program code for retrieving said advertisement file corresponding to said demographics information.
